(19) United States
(12) Patent Application Publication
(10) Pub. No.: US 2022/0227210 A1
(43) Pub. Date: Jul. 21, 2022

(54) OPENING AND CLOSING BODY CONTROL APPARATUS FOR VEHICLE

(71) Applicant: AISIN CORPORATION, Kariya (JP)

(72) Inventors: Tatsuo KAMAKURA, Kariya-shi (JP); Yi ZHANG, Kariya-shi (JP); Atsushi TAKEMOTO, Kariya-shi (JP)

(73) Assignee: AISIN CORPORATION, Kariya (JP)

(21) Appl. No.: 17/563,597

(22) Filed: Dec. 28, 2021

(30) Foreign Application Priority Data
Jan. 20, 2021 (JP) 2021-007255

(51) Int. Cl. B60J 7/057; B60J 7/043; B60J 7/00

(52) U.S. Cl. CPC B60J 7/0573; B60J 7/0015; B60J 7/0435

(57) ABSTRACT

An opening and closing body control apparatus for a vehicle includes: a sunroof device that opens and closes a movable panel provided in a roof opening of a vehicle; a shade device that opens and closes a light shielding member provided below the movable panel; and a drive circuit that supplies drive power to first and second motors that drive the sunroof device and the shade device, respectively. The drive circuit includes first to third arms connected in parallel in three rows and each including first and second switching elements connected in series, and by turning on the first or second switching element in the first, second or third arm and the first or second switching element in the first, second or third arm, the first or second motor is rotated forward or backward to drive the sunroof device or the shade device to be opened or closed.

### CROSS REFERENCE TO RELATED APPLICATIONS

This application is based on and claims priority under 35 U.S.C. § 119 to Japanese Patent Application 2021-007255, filed on Jan. 20, 2021, the entire content of which is incorporated herein by reference.

### TECHNICAL FIELD

This disclosure relates to an opening and closing body control apparatus for a vehicle.

### BACKGROUND DISCUSSION

In the related art, for example, as in JP 2003-333895A (Reference 1), there is disclosed a method for driving a plurality of motors with a drive circuit. The drive circuit includes a plurality of arms connected in parallel and each including first and second switching elements connected in series. One of the plurality of arms is shared by two motors. The “arm” is an abbreviation for “switching arm”. Some vehicles include a sunroof device that opens and closes a movable panel provided in a roof opening of the vehicle, and a shade device that opens and closes a light shielding member provided below the movable panel. In many cases, the sunroof device and the shade device are driven by motors provided independently of each other.

In the drive circuit in the related art, the plurality of motors are connected in series when being rotated in the same direction. Therefore, it may be difficult to apply the drive circuit in the related art to the sunroof device and the shade device as described above.

### SUMMARY

An opening and closing body control apparatus for a vehicle for solving the above problem includes: a sunroof device configured to open and close a movable panel provided in a roof opening of a vehicle; a shade device configured to open and close a light shielding member provided below the movable panel; and a drive circuit configured to supply drive power to a first motor that drives the sunroof device and a second motor that drives the shade device. The drive circuit includes first to third arms connected in parallel in three rows and each including first and second switching elements connected in series, by turning on the second switching element in the first arm and the first switching element in the second arm, the first motor is rotated forward to drive the sunroof device to be opened, by turning on the second switching element in the third arm and the first switching element in the second arm, the second motor is rotated forward to drive the shade device to be opened, by turning on the first switching element in the first arm and the second switching element in the second arm, the first motor is rotated backward to drive the sunroof device to be closed, and by turning on the first switching element in the third arm and the second switching element in the second arm, the second motor is rotated backward to drive the shade device to be closed.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a vehicle showing a roof panel, a roof opening, and a movable panel;

FIG. 2 is a schematic configuration diagram of a sunroof device;

FIG. 3 is a schematic configuration diagram of a shade device;

FIG. 4 is a schematic configuration diagram of an opening and closing body control apparatus for a vehicle;

FIG. 5 is a circuit diagram of the opening and closing body control apparatus for a vehicle;

FIG. 6 is a circuit diagram of the opening and closing body control apparatus for a vehicle;

FIG. 7 is a circuit diagram of the opening and closing body control apparatus for a vehicle;

FIG. 8 is a diagram showing an operation of the opening and closing body control apparatus for a vehicle;

FIG. 9 is a diagram showing an operation of the opening and closing body control apparatus for a vehicle;

FIG. 10 is a diagram showing an operation of the opening and closing body control apparatus for a vehicle;

FIG. 11 is a diagram showing an operation of the opening and closing body control apparatus for a vehicle;

FIG. 12 is a diagram showing an operation of the opening and closing body control apparatus for a vehicle;

FIG. 13 is a diagram showing an operation of the opening and closing body control apparatus for a vehicle;

FIG. 14 is a flowchart showing an aspect of opening and closing drive control based on an opening and closing operation request;

FIG. 15 is a flowchart showing an aspect of opening and closing drive control based on detection of pinching; and

FIG. 16 is a flowchart showing another example of the opening and closing drive control based on detection of pinching.

### DETAILED DESCRIPTION

Hereinafter, an embodiment of an opening and closing body control apparatus for a vehicle will be described with reference to the drawings.

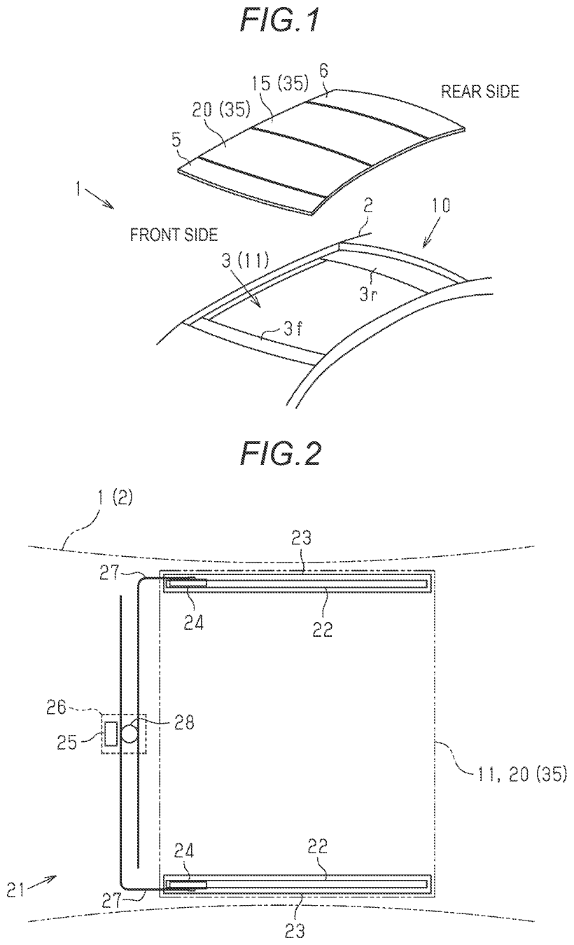

As shown in FIG. 1, a vehicle 1 according to the present embodiment includes a substantially rectangular upper opening 3 facing upward on an upper portion of a vehicle body 2. A substantially rectangular plate-shaped front panel 5 extending in a vehicle width direction is fixed to a front edge portion 3f of the upper opening 3. Similarly, a substantially rectangular plate-shaped rear panel 6 extending in the vehicle width direction is fixed to a rear edge portion 3r of the upper opening 3. In the vehicle 1 according to the present embodiment, a roof panel 10 is constituted by the front panel 5 and the rear panel 6.

A roof opening 11 formed between the front panel 5 and the rear panel 6 is provided with a substantially rectangular plate-shaped fixed panel 15 and a substantially rectangular plate-shaped movable panel 20 that also extend in the vehicle width direction.

In the vehicle 1 according to the present embodiment, the fixed panel 15 and the movable panel 20 are formed by, for example, a light transmissive material such as glass or resin. In the vehicle 1 according to the present embodiment, the movable panel 20 is provided in front of the fixed panel 15 fixed to the upper opening 3 of the vehicle body 2 together with the front panel 5 and the rear panel 6. In the vehicle 1 according to the present embodiment, when the movable panel 20 is in a fully closed state, the front panel 5 located in front of the movable panel 20, and the fixed panel 15 and the rear panel 6 located behind the movable panel 20 are substantially in the same plane. The vehicle 1 according to the present embodiment is provided with a sunroof device 21 that opens and closes the movable panel 20 in a vehicle front-rear direction.

More specifically, as shown in FIG. 2, the sunroof device 21 according to the present embodiment includes a pair of left and right support members 22, 22 that support the movable panel 20 in the roof opening 11. The sunroof device 21 further includes, at both end sides of the roof opening 11 in a width direction, guide rails 23, 23 that extend in the vehicle front-rear direction (left-right direction in FIG. 2). The sunroof device 21 further includes a pair of left and right slide members 24, 24 that slide along a longitudinal direction of the guide rails 23, 23 in a state of being coupled to the support members 22, 22. In the sunroof device 21 according to the present embodiment, the movable panel 20 performs the opening and closing operation by sliding of the slide members 24, 24.

The sunroof device 21 according to the present embodiment further includes an actuator 26 including a motor 25 as a drive source. In the vehicle 1 according to the present embodiment, the actuator 26 is fixed inside the roof opening 11 at a position below the front panel 5 on a vehicle front side (left side in FIG. 2) of the roof panel 10. The sunroof device 21 according to the present embodiment further includes a pair of drive cables 27, 27 routed along the left and right guide rails 23, 23. The actuator 26 according to the present embodiment includes a drive gear 28. The drive cables 27, 27 are meshed with the drive gear 28 at two positions where a rotation shaft of the drive gear 28 is sandwiched by the drive cables 27, 27. In the sunroof device 21 according to the present embodiment, the slide members 24, 24 slide in the vehicle front-rear direction by a driving force of the actuator 26 transmitted via the drive cables 27, 27.

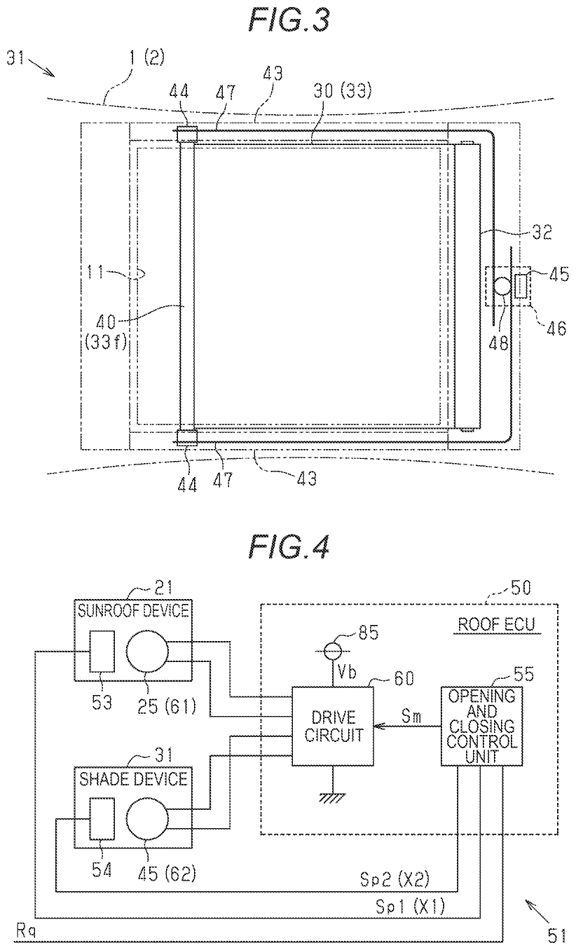

As shown in FIG. 3, the vehicle 1 according to the present embodiment includes a shade device 31 that opens and closes a light shielding member 30 provided below the movable panel 20. Specifically, the vehicle 1 according to the present embodiment includes a winding machine 32 provided inside the roof opening 11, and a cloth light shielding sheet 33 coupled to the winding machine 32. In the vehicle 1 according to the present embodiment, the winding machine 32 is fixed inside the roof opening 11 at a position below the rear panel 6 on a vehicle rear side (right side in FIG. 3) of the roof panel 10. The light shielding sheet 33 is spread below the movable panel 20 having a configuration serving as a light transmitting panel 35 when being pulled out from the winding machine 32 toward the vehicle front side (left side in FIG. 3). Accordingly, in the shade device 31 according to the present embodiment, the light shielding sheet 33 serving as the light shielding member 30 performs a closing operation.

More specifically, the shade device 31 according to the present embodiment includes, at a position closer to the vehicle front side than the winding machine 32, an elongated substantially plate-shaped garnish 40 fixed to one end of the light shielding sheet 33 in a state of extending in the vehicle width direction (up and down direction in FIG. 3). The shade device 31 further includes, at both end sides of the roof opening 11 in the width direction, guide rails 43, 43 that extend in the vehicle front-rear direction. In the vehicle 1 according to the present embodiment, the guide rails 43, 43 of the shade device 31 are formed integrally with the guide rails 23, 23 of the sunroof device 21, respectively. The shade device 31 further includes a pair of left and right slide members 44, 44 that slide along a longitudinal direction of the guide rails 43, 43 in a state of being fixed to both end portions of the garnish 40 in the longitudinal direction. In the shade device 31 according to the present embodiment, the light shielding sheet 33 performs the opening and closing operation by sliding of the slide members 44, 44.

The shade device 31 according to the present embodiment further includes an actuator 46 including a motor 45 as a drive source. In the vehicle 1 according to the present embodiment, the actuator 46 is fixed inside the roof opening 11 at a position closer to the vehicle rear side than the winding machine 32 of the light shielding sheet 33. The shade device 31 according to the present embodiment further includes a pair of drive cables 47, 47 routed along the left and right guide rails 23, 23. The actuator 46 according to the present embodiment includes a drive gear 48. The drive cables 47, 47 are meshed with the drive gear 48 at two positions where a rotation shaft of the drive gear 48 is sandwiched by the drive cables 47, 47. In the shade device 31 according to the present embodiment, the slide members 44, 44 slide in the vehicle front-rear direction by a driving force of the actuator 46 transmitted via the drive cables 47, 47.

That is, as shown in FIG. 2, the sunroof device 21 according to the present embodiment is driven by the motor to open the movable panel 20 by moving the movable panel 20 to the vehicle rear side, and to close the movable panel 20 by moving the movable panel 20 to the vehicle front side. As shown in FIG. 3, the shade device 31 according to the present embodiment is driven by the motor to open the light shielding sheet 33 by winding the light shielding sheet 33 on the winding machine 32 on the vehicle rear side, and to close the light shielding sheet 33 by pulling out the light shielding sheet 33 wound around the winding machine 32 toward the vehicle front side.

As shown in FIG. 4, in the vehicle 1 according to the present embodiment, operations of the sunroof device 21 and the shade device 31 are controlled by a roof ECU 50. Accordingly, in the vehicle 1 according to the present embodiment, an opening and closing body control apparatus for a vehicle 51 is obtained. The opening and closing body control apparatus for a vehicle 51 can integrally control opening and closing operations of the movable panel 20 and the light shielding sheet 33 serving as the light shielding member 30 provided in the roof opening 11.

Specifically, the roof ECU 50 according to the present embodiment receives, based on an operation input to an operation switch (not shown) provided in a vehicle interior, an opening and closing operation request Rq for the movable panel 20 and the light shielding sheet 33 serving as the light shielding member 30 provided in the roof opening 11. Then, based on the opening and closing operation request Rq, the roof ECU 50 supplies drive power to the motor 25 of the sunroof device 21 and supplies drive power to the motor 45 of the shade device 31.

More specifically, in the vehicle 1 according to the present embodiment, the actuator 26 of the sunroof device 21 is provided with a pulse sensor 53 that outputs a pulse signal Sp1 synchronized with rotation of the motor 25 serving as the drive source of the actuator 26. Similarly, the actuator 46 of the shade device 31 is also provided with a pulse sensor 54 that outputs a pulse signal Sp2 synchronized with rotation of the motor 45 serving as the drive source of the actuator 46. The roof ECU 50 according to the present embodiment detects opening and closing operation positions X1, X2 of the movable panel 20 and the light shielding sheet 33 by counting the pulse signals Sp1, Sp2.

The roof ECU 50 according to the present embodiment monitors changes in the pulse signals Sp1 and Sp2. Based on the changes in the pulse signals Sp1, Sp2 and the opening and closing operation positions X1, X2 of the movable panel 20 and the light shielding sheet 33, the roof ECU 50 independently detects pinching generated in the movable panel 20 and the light shielding sheet 33. Accordingly, the opening and closing body control apparatus for a vehicle 51 according to the present embodiment has a pinching avoidance mode that controls operations of the sunroof device 21 and the shade device 31 based on pinching detection.

More specifically, in the roof ECU 50 according to the present embodiment, the above opening and closing operation request Rq and the pulse signals Sp1, Sp2 are input to an opening and closing control unit 55. The opening and closing control unit 55 generates a motor control signal Sm for driving the sunroof device 21 and the shade device 31 based on the opening and closing operation request Rq and the pulse signals Sp1, Sp2. The roof ECU 50 according to the present embodiment includes a drive circuit 60 that is able to independently supply the drive power to the motor 25 of the sunroof device 21 and the motor 45 of the shade device 31 based on the motor control signal Sm.

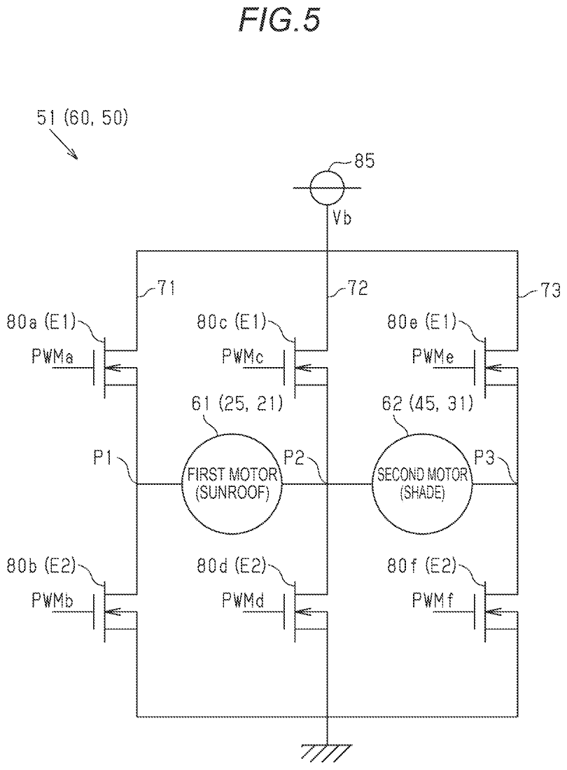

As shown in FIG. 5, in the opening and closing body control apparatus for a vehicle 51 according to the present embodiment, a first motor 61 constituting the motor 25 of the sunroof device 21 and a second motor 62 constituting the motor 45 of the shade device 31 each have a configuration serving as a brushed DC motor. For the first and second motors 61 and 62, motors of the same model number having the same output characteristics are used. A PWM inverter, which is formed by connecting a plurality of switching elements (FETs: Field effect transistors) in a bridge shape, is used in the drive circuit 60 according to the present embodiment. The plurality of switching elements performs an on/off operation based on the motor control signal Sm output from the opening and closing control unit 55.

Specifically, in the drive circuit 60 according to the present embodiment, a switching arm is formed by connecting first and second switching elements E1 and E2 provided in pairs in series. Hereinafter, for convenience of description, the “switching arm” is referred to as “arm” that is an abbreviation for “switching arm”. The drive circuit 60 according to the present embodiment includes first to third arms 71 to 73 connected in parallel in three rows and each including the first and second switching elements E1 and E2 connected in series.

More specifically, in the drive circuit 60 according to the present embodiment, the first arm 71 includes a pair of FETs 80a and 80b constituting the first and second switching elements E1 and E2. The second arm 72 includes a pair of FETs 80c and 80d constituting the first and second switching elements E1 and E2. The third arm 73 includes a pair of FETs 80e and 80f constituting the first and second switching elements E1 and E2.

In the first to third arms 71 to 73, an output voltage Vb of an in-vehicle power supply 85 is applied to each of the FETs 80a, 80c, and 80e on an upstream side (upper side in FIG. 5) constituting the first switching elements E1. Each of the FETs 80b, 80d, and 80f on a downstream side (lower side in FIG. 5) constituting the second switching elements E2 is grounded.

In the opening and closing body control apparatus for a vehicle 51 according to the present embodiment, the first motor 61 that drives the sunroof device 21 is connected to a connection point P1 of the FETs 80a and 80b constituting the first arm 71 and a connection point P2 of the FETs 80c and 80d constituting the second arm 72. The second motor 62 that drives the shade device 31 is connected to the connection point P2 of the FETs 80c and 80d constituting the second arm 72 and a connection point P3 of the FETs 80e and 80f constituting the third arm 73.

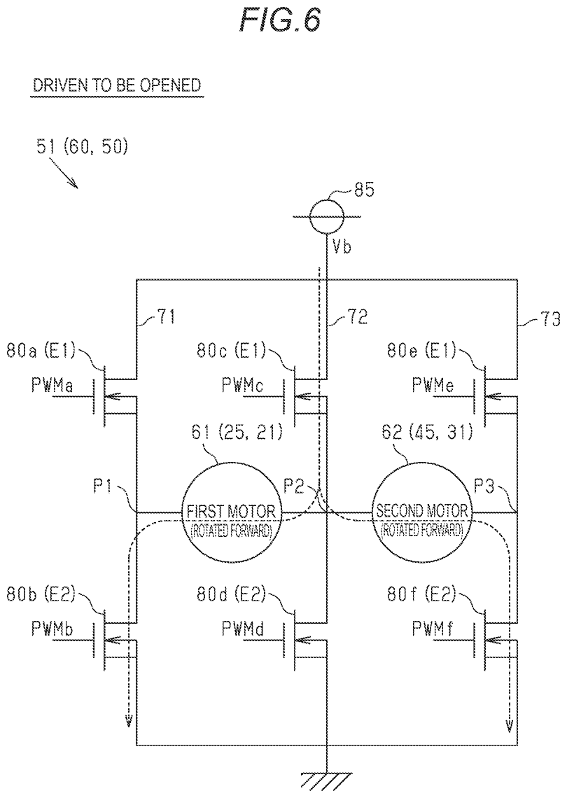

More specifically, as shown in FIG. 6, the opening and closing body control apparatus for a vehicle 51 according to the present embodiment turns on the FET 80b and the FET 80c of the drive circuit 60. That is, by turning on the second switching element E2 in the first arm 71 and the first switching element E1 in the second arm 72, the first motor 61 is rotated forward to drive the sunroof device 21 to be opened. The opening and closing body control apparatus for a vehicle 51 turns on the FET 80f and the FET 80c of the drive circuit 60. That is, by turning on the second switching element E2 in the third arm 73 and the first switching element E1 in the second arm 72, the second motor 62 is rotated forward to drive the shade device 31 to be opened.

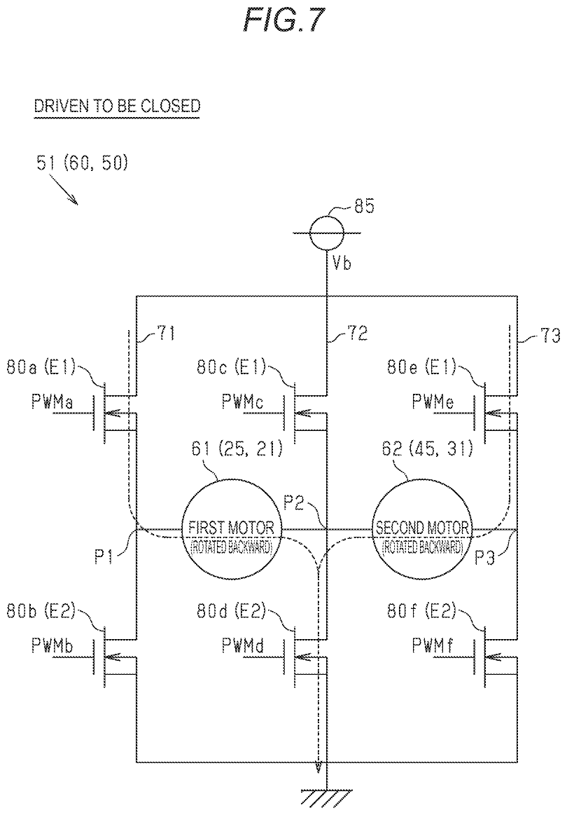

As shown in FIG. 7, the opening and closing body control apparatus for a vehicle 51 according to the present embodiment turns on the FET 80a and the FET 80d of the drive circuit 60. That is, by turning on the first switching element E1 in the first arm 71 and the second switching element E2 in the second arm 72, the first motor 61 is rotated backward to drive the sunroof device 21 to be closed. The opening and closing body control apparatus for a vehicle 51 turns on the FET 80e and the FET 80d of the drive circuit 60. That is, by turning on the first switching element E1 in the third arm 73 and the second switching element E2 in the second arm 72, the second motor 62 is rotated backward to drive the shade device 31 to be closed.

That is, both the movable panel 20 and the light shielding member 30 provided in the roof opening 11 of the vehicle 1 perform the opening operation and the closing operation in the same direction. Based on this point, in the opening and closing body control apparatus for a vehicle 51 according to the present embodiment, a rotation direction of the first motor 61 that drives the sunroof device 21 to be opened is the same as a rotation direction of the second motor 62 that drives the shade device 31 to be opened. A rotation direction of the first motor 61 that drives the sunroof device 21 to be closed is the same as a rotation direction of the second motor 62 that drives the shade device 31 to be closed. Accordingly, in the opening and closing body control apparatus for a vehicle 51 according to the present embodiment, a design of drive control for the sunroof device 21 and the shade device 31, in particular, a design of opening and closing drive control by which the sunroof device 21 and the shade device 31 are linked with each other can be easily performed.

In the roof ECU 50 according to the present embodiment, the motor control signal Sm output from the opening and closing control unit 55 is converted into PWM control signals PWMa to PWMf and is input to the FETs 80a to 80f of the drive circuit 60, respectively. Accordingly, the roof ECU 50 according to the present embodiment can supply independent drive power to each of the first motor 61 that drives the sunroof device 21 and the second motor 62 that drives the shade device 31.

Specifically, when the sunroof device 21 is driven to be opened, the FET 80b of the drive circuit 60, that is, the second switching element E2 in the first arm 71 is driven to be turned on/off by PWM control, so that the drive power supplied to the first motor 61 is controlled. Then, when the sunroof device 21 is driven to be closed, the FET 80a of the drive circuit 60, that is, the first switching element E1 in the first arm 71 is driven to be turned on/off by the PWM control, so that the drive power supplied to the first motor 61 is controlled.

Further, when the shade device 31 is driven to be opened, the FET 80f of the drive circuit 60, that is, the second switching element E2 in the third arm 73 is driven to be turned on/off by the PWM control, so that the drive power supplied to the second motor 62 is controlled. Then, when the shade device 31 is driven to be closed, the FET 80e of the drive circuit 60, that is, the first switching element E1 in the third arm 73 is driven to be turned on/off by the PWM control, so that the drive power supplied to the second motor 62 is controlled.

That is, the movable panel 20 driven by the sunroof device 21 and the light shielding sheet 33 driven by the shade device 31 are different in size and weight. Therefore, a driving force required for the opening and closing operation of the movable panel 20 and a driving force required for the opening and closing operation of the light shielding sheet 33 are different. However, the opening and closing body control apparatus for a vehicle 51 according to the present embodiment can individually control the driving forces by the above configuration. That is, even when the first and second motors 61 and 62 having the same output characteristics are used, an opening and closing operation speed of the movable panel 20 and an opening and closing operation speed of the light shielding sheet 33 can be freely set. Accordingly, in the opening and closing body control apparatus for a vehicle 51 according to the present embodiment, the configuration can be simplified and the cost can be reduced by commonalizing specifications of the motor 25 of the sunroof device 21 and the motor 45 of the shade device 31.

Next, the opening and closing control of the movable panel 20 and the light shielding sheet 33 of the opening and closing body control apparatus for a vehicle 51 according to the present embodiment will be described.

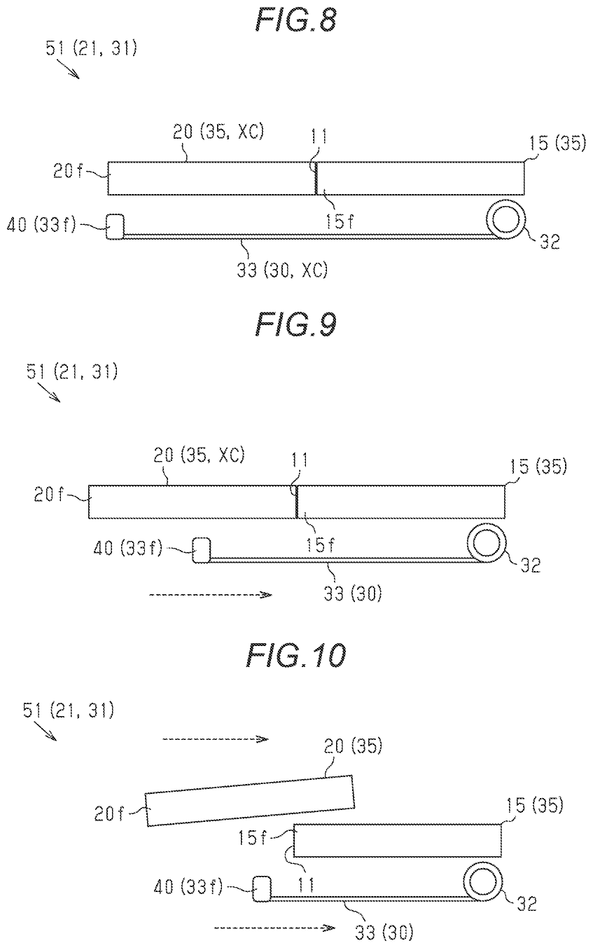

As shown in FIGS. 8 to 10, in the opening and closing body control apparatus for a vehicle 51 according to the present embodiment, when both the movable panel 20 and the light shielding sheet 33 perform the opening operations from a state in which both the movable panel 20 and the light shielding sheet 33 are at fully closed positions XC, the opening operation of the movable panel 20 is started after the opening operation of the light shielding sheet 33 is started.

That is, in the opening and closing body control apparatus for a vehicle 51 according to the present embodiment, the movable panel 20 and the light shielding sheet 33 quickly reach fully open positions XO by making the movable panel 20 and the light shielding sheet 33 simultaneously perform the opening operations. In the opening and closing body control apparatus for a vehicle 51, the light shielding sheet 33 performs the opening operation first, so that the movable panel 20 keeps covering the light shielding sheet 33 spread inside the roof opening 11 from above. Accordingly, the light shielding sheet 33 is protected.

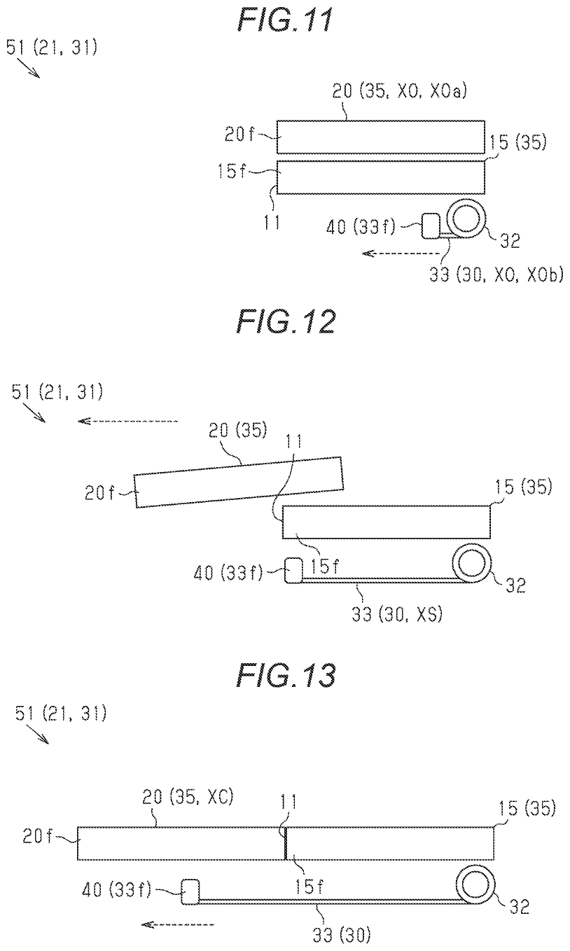

As shown in FIGS. 11 to 13, in the opening and closing body control apparatus for a vehicle 51 according to the present embodiment, when both the movable panel 20 and the light shielding member 33 perform the closing operations from a state in which both the movable panel 20 and the light shielding member 33 are at the fully open positions XO, the closing operation of the light shielding sheet 33 is started before the closing operation of the movable panel 20 is started. The light shielding sheet 33 is stopped in the middle at a position closer to an open side than a fully open position XOa of the movable panel 20.

In the opening and closing body control apparatus for a vehicle 51 according to the present embodiment, the movable panel 20 performs the closing operation while the light shielding sheet 33 is stopped in the middle. In the opening and closing body control apparatus for a vehicle 51 according to the present embodiment, an opening and closing operation position X1 of the movable panel 20 and an opening and closing operation position X2 of the light shielding sheet 33 are based on a front end position 20f of the movable panel 20 and a front end position 33f of the light shielding sheet 33, respectively. After the closing operation of the movable panel 20 is completed, that is, the movable panel 20 reaches the fully closed position XC or reaches a position desired by a user, the closing operation of the light shielding sheet 33 is restarted.

That is, in the vehicle 1 according to the present embodiment, the fixed panel 15 provided on a rear side of the movable panel 20 also has a configuration serving as the light transmitting panel 35. Therefore, a fully open position XOb of the light shielding sheet 33 is set closer to the vehicle rear side than the fully open position XOa of the movable panel 20.

In other words, in the opening and closing body control apparatus for a vehicle 51 according to the present embodiment, an opening and closing operation range of the light shielding sheet 33 extends to the vehicle rear side (right side in each drawing) that is an opening operation side of the light shielding sheet 33 than an opening and closing operation range of the movable panel 20. Based on this point, in the opening and closing body control apparatus for a vehicle 51 according to the present embodiment as described above, the light shielding sheet 33 located closer to the open side than the fully open position XOa of the movable panel 20 performs the closing operation ahead of the movable panel 20. A middle stop position XS of the light shielding sheet 33 is located slightly closer to the vehicle rear side than the fully open position XOa of the movable panel 20. When the movable panel 20 overlaps the fixed panel 15 from above, the front end position 20f substantially coincides with a front end position 15f of the fixed panel 15. Accordingly, in the opening and closing body control apparatus for a vehicle 51 according to the present embodiment, while maintaining a fully open state of the movable panel 20, the light shielding sheet 33 can cover the fixed panel 15 having a configuration serving as the light transmitting panel 35 from below.

In the opening and closing body control apparatus for a vehicle 51 according to the present embodiment, the movable panel 20 and the light shielding sheet 33 do not simultaneously perform the closing operations, so that even when the user stops the movable panel 20 at a middle position, the light shielding sheet 33 performing the closing operation does not overtake the movable panel 20. Accordingly, the movable panel 20 would not be forgotten to be closed when the light shielding sheet 33 after performing the closing operation is exposed to the roof opening 11.

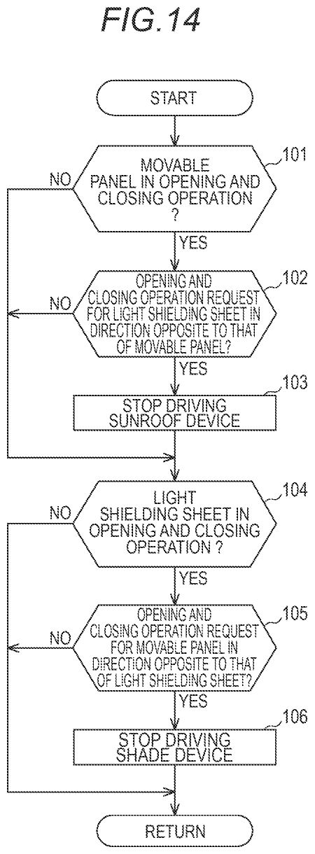

As shown in a flowchart in FIG. 14, when the movable panel 20 is in the opening and closing operation (step 101: YES), the roof ECU 50 according to the present embodiment determines whether there is an opening and closing operation request Rq for an opening and closing operation direction of the light shielding sheet 33 opposite to that of the movable panel 20 (step 102). Specifically, it is determined whether there is a closing operation request for the light shielding sheet 33 during the opening operation of the movable panel 20 or whether there is an opening operation request for the light shielding sheet 33 during the closing operation of the movable panel 20. Then, the roof ECU 50 according to the present embodiment stops driving the sunroof device 21 when there is such an opening and closing operation request Rq for the opening and closing operation direction of the light shielding sheet 33 opposite to that of the movable panel 20. That is, supply of the drive power to the motor 25 is stopped to stop the opening and closing operation of the movable panel 20 (step 103).

Similarly, when the light shielding sheet 33 is in the opening and closing operation (step 104: YES), the roof ECU 50 according to the present embodiment determines whether there is an opening and closing operation request Rq for the opening and closing operation direction of the movable panel 20 opposite to that of the light shielding sheet 33 (step 105). Specifically, it is determined whether there is a closing operation request for the movable panel 20 during the opening operation of the light shielding sheet 33 or whether there is an opening operation request for the movable panel 20 during the closing operation of the light shielding sheet 33. Then, the roof ECU 50 according to the present embodiment stops driving the shade device 31 when there is such an opening and closing operation request Rq for the opening and closing operation direction of the movable panel 20 opposite to that of the light shielding sheet 33. That is, supply of the drive power to the motor 45 is stopped to stop the opening and closing operation of the light shielding sheet 33 (step 106).

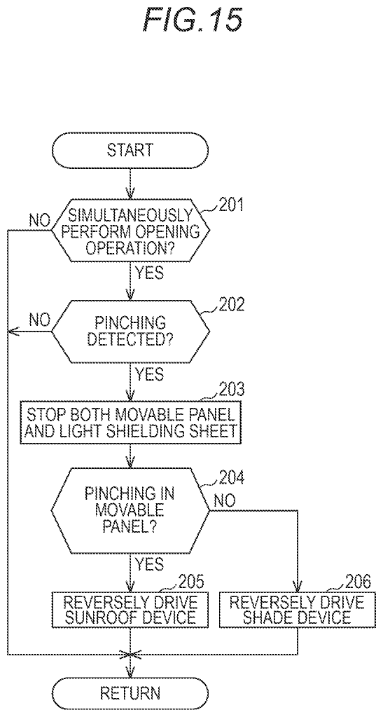

As shown in a flowchart in FIG. 15, the roof ECU 50 according to the present embodiment determines whether the movable panel 20 and the light shielding sheet 33 simultaneously perform the opening operations (step 201). When the movable panel 20 and the light shielding sheet 33 simultaneously perform the opening operations (step 201: YES) and the pinching is detected in either one of the movable panel 20 and the light shielding sheet 33 (step 202: YES), both the sunroof device 21 and the shade device 31 are stopped. That is, both the movable panel 20 and the light shielding sheet 33 are stopped (step 203). When the pinching occurs in the movable panel 20 (step 204: YES), only the sunroof device 21 is reversely driven (step 205), and when the pinching occurs in the light shielding sheet 33 (step 204: NO), only the shade device 31 is reversely driven (step 206).

Next, actions of the present embodiment will be described.

In the opening and closing body control apparatus for a vehicle 51 according to the present embodiment, the rotation direction of the first motor 61 that drives the sunroof device 21 to be opened is the same as the rotation direction of the second motor 62 that drives the shade device 31 to be opened. The rotation direction of the first motor 61 that drives the sunroof device 21 to be closed is the same as the rotation direction of the second motor 62 that drives the shade device 31 to be closed. The drive power supplied to the first motor 61 is controlled independently of the drive power supplied to the second motor 62. Accordingly, the opening and closing operations and the driving forces of the sunroof device 21 and the shade device 31 are individually controlled.

Next, effects of the present embodiment will be described.

(1) The opening and closing body control apparatus for a vehicle 51 includes the sunroof device 21 that opens and closes the movable panel 20 provided in the roof opening 11 of the vehicle 1. The opening and closing body control apparatus for a vehicle 51 further includes the shade device 31 that opens and closes the light shielding sheet 33 serving as the light shielding member 30 provided below the movable panel 20. The opening and closing body control apparatus for a vehicle 51 further includes the drive circuit 60 that supplies the drive power to the first motor 61 and the second motor 62. The first motor 61 drives the sunroof device 21, and the second motor 62 drives the shade device 31.

The drive circuit 60 includes the first to third arms 71 to 73 connected in parallel in three rows and each including the first and second switching elements E1 and E2 connected in series. By turning on the second switching element E2 in the first arm 71 and the first switching element E1 in the second arm 72, the first motor 61 is rotated forward to drive the sunroof device 21 to be opened. By turning on the second switching element E2 in the third arm 73 and the first switching element E1 in the second arm 72, the second motor 62 is rotated forward to drive the shade device 31 to be opened. By turning on the first switching element E1 in the first arm 71 and the second switching element E2 in the second arm 72, the first motor 61 is rotated backward to drive the sunroof device 21 to be closed. By turning on the first switching element E1 in the third arm 73 and the second switching element E2 in the second arm 72, the second motor 62 is rotated backward to drive the shade device 31 to be closed.

According to the above configuration, the sunroof device 21 and the shade device 31 can be individually driven with a simple configuration. Both the movable panel 20 and the light shielding sheet 33 serving as the light shielding member 30 provided in the roof opening 11 of the vehicle 1 perform the opening operation and the closing operation in the same direction. The first motor 61 that drives the sunroof device 21 and the second motor 62 that drives the shade device 31 are also rotated in the same direction when performing opening drive and closing drive. Therefore, according to the above configuration, the design of the drive control for the sunroof device 21 and the shade device 31, in particular, the design of the opening and closing drive control by which the sunroof device 21 and the shade device 31 are linked with each other can be easily performed. Accordingly, the sunroof device and the shade device can be suitably driven to be opened and closed.

(2) When the sunroof device 21 is driven to be opened, the second switching element E2 in the first arm 71 is driven to be turned on/off by the PWM control. When the shade device 31 is driven to be opened, the second switching element E2 in the third arm 73 is driven to be turned on/off by the PWM control. When the sunroof device 21 is driven to be closed, the first switching element E1 in the first arm 71 is driven to be turned on/off by the PWM control. When the shade device 31 is driven to be closed, the first switching element E1 in the third arm 73 is driven to be turned on/off by the PWM control.

That is, the movable panel 20 driven by the sunroof device 21 and the light shielding sheet 33 driven by the shade device 31 are different in size and weight. However, according to the above configuration, individual control can be performed in accordance with the driving force required for the opening and closing operation of the movable panel 20 and the driving force required for the opening and closing operation of the light shielding sheet 33. As a result, for example, the opening and closing operation speed of the movable panel 20 and the opening and closing operation speed of the light shielding sheet 33 can be freely set. Accordingly, a degree of freedom for the design of the opening and closing drive control can be increased.

The driving force of the sunroof device 21 and the driving force of the shade device 31 can be individually controlled without driving the first and second switching elements E1 and E2 constituting the second arm 72 to be turned on/off by the PWM control. Accordingly, when the sunroof device 21 and the shade device 31 are driven, a load on the first switching element E1 or the second switching element E2 in the second arm 72, that is, a switching element through which both a current supplied to the sunroof device 21 and a current supplied to the shade device 31 flow, can be reduced.

(3) The first and second motors 61 and 62 have the same output characteristics.

According to the above configuration, the configuration can be simplified and the cost can be reduced by commonalizing specifications of the first motor 61 that drives the sunroof device 21 and the second motor 62 that drives the shade device 31.

(4) When both the movable panel 20 and the light shielding sheet 33 serving as the light shielding member 30 perform opening operations from the state in which both the movable panel 20 and the light shielding sheet 33 are at the fully closed positions XC, the opening operation of the movable panel 20 is started after the opening operation of the light shielding sheet 33 is started.

That is, the light shielding sheet 33 performs the opening operation first, so that the state the movable panel 20 covers the light shielding sheet 33 spread inside the roof opening 11 from above can be maintained. Accordingly, the light shielding sheet 33 can be protected. As a result, the movable panel 20 and the light shielding sheet 33 can simultaneously perform the opening operations and quickly reach the fully open positions XO thereof.

(5) When both the movable panel 20 and the light shielding sheet 33 perform closing operations from the state in which both the movable panel 20 and the light shielding sheet 33 are at the fully open positions XO, the closing operation of the light shielding sheet 33 is started before the closing operation of the movable panel 20 is started. Further, the light shielding sheet 33 is stopped in the middle at a position closer to the open side than the fully open position XOa of the movable panel 20, and the movable panel 20 performs the closing operation while the light shielding sheet 33 is stopped in the middle. Then, the closing operation of the light shielding sheet 33 is restarted after the closing operation of the movable panel is completed.

According to the above configuration, the movable panel 20 and the light shielding sheet 33 do not simultaneously perform the closing operations, so that even when the user stops the movable panel 20 at a middle position, the light shielding sheet 33 performing the closing operation does not overtake the movable panel 20. Accordingly, it is possible to prevent the movable panel 20 from being forgotten to be closed when the light shielding sheet 33 after performing the closing operation is exposed to the roof opening 11. Accordingly, the load on the first switching element E1 or the second switching element E2 in the second arm 72, that is, a switching element through which both the current supplied to the sunroof device 21 and the current supplied to the shade device 31 flow, can be reduced.

In the vehicle 1, the opening and closing operation range of the light shielding sheet 33 may extend to the vehicle rear side serving as the opening operation side of the light shielding sheet 33 than the opening and closing operation range of the movable panel 20. However, according to the above configuration, the light shielding sheet 33 located closer to the open side than the fully open position XOa of the movable panel 20 performs the closing operation ahead of the movable panel 20, so that the whole closing operation time can be shortened.

When the roof panel 10 closer to the closed side than the movable panel 20 in the fully closed position XC has a configuration serving as the light transmitting panel 35, the light shielding sheet 33, which performs the opening operation first, covers the light transmitting panel 35 from below. Accordingly, when the movable panel 20 is at the fully open position XOa, a light shielding effect by the light shielding sheet 33 can also be obtained.

(6) During the opening and closing operation of one of the movable panel 20 and the light shielding sheet 33, when there is an opening and closing operation request for the other one of the movable panel 20 and the light shielding sheet 33 to perform the opening and closing operation in a direction opposite to the one of the movable panel 20 and the light shielding sheet 33, the opening and closing operation of the one of the movable panel 20 and the light shielding sheet 33 is stopped.

According to the above configuration, the movable panel 20 and the light shielding sheet 33 do not perform the opening and closing operation in opposite directions by the operation of the user. Accordingly, it is possible to avoid occurrence of a situation in which the first motor 61 that drives the sunroof device 21 and the second motor 62 that drives the shade device 31 are rotated in opposite directions.

(7) When the movable panel 20 and the light shielding sheet 33 simultaneously perform the opening operations and the pinching is detected in either one of the movable panel 20 and the light shielding sheet 33, both the movable panel 20 and the light shielding sheet 33 are stopped. Then, only one of the movable panel 20 and the light shielding sheet 33 in which the pinching is detected performs a reverse operation.

According to the above configuration, the movable panel 20 and the light shielding sheet 33 do not perform the opening and closing operation in opposite directions even during the reverse operation due to the detection of the pinching. Accordingly, it is possible to avoid occurrence of a situation in which the first motor 61 that drives the sunroof device 21 and the second motor 62 that drives the shade device 31 are rotated in opposite directions.

The above embodiment can be modified and implemented as follows. The above embodiment and the following modifications can be implemented in combination with each other as long as the embodiment and the modifications do not have technical contradiction.

In the above embodiment, the shade device 31 includes a roll shade configuration in which the cloth light shielding sheet 33 wound around the winding machine 32 is used as the light shielding member 30. Alternatively, the shade device 31 may be applied to a configuration that opens and closes a plate-shaped light shielding member 30.

In the above embodiment, the sunroof device 21 includes an outer slide configuration in which the movable panel 20 performs the opening operation above the roof panel 10. Alternatively, the sunroof device 21 may be applied to an inner slide configuration in which the movable panel 20 performs the opening operation below the roof panel 10.

The shape, size, arrangement, and the like of the roof opening 11 in which the sunroof device 21 and the shade device 31 are provided may be optionally changed. Further, the opening and closing operation ranges of the movable panel 20 and the light shielding member 30 may be optionally set. The opening and closing operation direction of the movable panel 20 and the light shielding member 30 may also be optionally changed as long as the movable panel 20 and the light shielding member 30 perform the opening operation and the closing operation in the same direction.

In the above embodiment, the first motor 61 constituting the motor 25 of the sunroof device 21 and the second motor 62 constituting the motor 45 of the shade device 31 have the same output characteristics. Alternatively, the output characteristics are not necessarily the same. For example, the first motor 61 having output characteristics conforming to the driving force required for the opening and closing operation of the movable panel 20 and the second motor 62 having output characteristics conforming to the driving force required for the opening and closing operation of the light shielding sheet 33 may be used. In this case, when the sunroof device 21 is driven and the shade device 31 is driven, the first and second switching elements E1 and E2 in the first arm 71 and the first and second switching elements E1 and E2 in the third arm 73 are not necessarily turned on/off by the PWM control.

In the first to third arms 71 to 73 constituting the drive circuit 60 in the above embodiment, the FETs 80a, 80c, and 80e on the upstream side to which the output voltage Vb of the in-vehicle power supply 85 is applied are set to the first switching element E1. The grounded FETs 80b, 80d, and 80f on the downstream side are set to the second switching element E2. However, the disclosure is not limited thereto, and the FETs 80a, 80c, and 80e on the high potential side may be set to the second switching element E2. The FETs 80b, 80d, and 80f on the low potential side may be set to the first switching element E1.

When the sunroof device 21 and the shade device 31 are driven to be opened, the second switching elements E2, E2 in the first arm 71 and the third arm 73 in the drive circuit 60 may not be simultaneously turned on. When the sunroof device 21 and the shade device 31 are driven to be closed, the first switching elements E1, E1 in the first arm 71 and the third arm 73 in the drive circuit 60 may not be simultaneously turned on. Specifically, a timing at which the first switching element E1 or the second switching element E2 in the first arm 71 is driven to be turned on/off by the PWM control may be shifted from a timing at which the first switching element E1 or the second switching element E2 in the third arm 73 is driven to be turned on/off by the PWM control. By adopting such a configuration, the load on the first switching element E1 or the second switching element E2 in the second arm 72, that is, a switching element through which both the current supplied to the sunroof device 21 and the current supplied to the shade device 31 flow, can be reduced.

In the above embodiment, a case has been described in which both the movable panel 20 and the light shielding sheet 33 serving as the light shielding member 30 perform the closing operations from the state in which both the movable panel 20 and the light shielding sheet 33 are in the fully open positions XO. Alternatively, the light shielding member 30 may be stopped while the movable panel 20 performs the closing operation regardless of a start position of the closing operation.

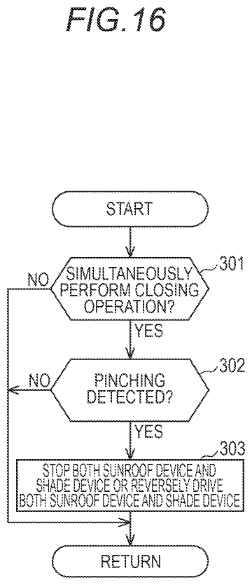

The movable panel 20 and the light shielding member 30 may simultaneously perform the closing operations. In this case, for example, as shown in a flowchart in FIG. 16, it is determined whether the movable panel 20 and the light shielding member 30 simultaneously perform the closing operations (step 301). When the movable panel 20 and the light shielding member 30 simultaneously perform the closing operations (step 301: YES), it is determined whether the pinching is detected in either one of the movable panel 20 and the light shielding member 30 (step 302). When the pinching is detected (step 302: YES), both the sunroof device 21 and the shade device 31 may be reversely driven after both the sunroof device 21 and the shade device 31 are stopped (step 303).

Next, technical ideas that can be understood from the above embodiment and modifications will be described.

(A) In an opening and closing body control apparatus for a vehicle, during an opening and closing operation of one of a movable panel and a light shielding member in an opening and closing body control apparatus for a vehicle, when there is an opening and closing operation request for the other one of the movable panel and the light shielding member to perform an opening and closing operation in a direction opposite to that of the one of the movable panel and the light shielding member, the opening and closing operation of the one of the movable panel and the light shielding member is stopped.

According to the above configuration, the movable panel and the light shielding member do not perform the opening and closing operations in opposite directions by an operation of a user. Accordingly, it is possible to avoid an occurrence of a situation in which a first motor that drives a sunroof device and a second motor that drives a shade device are rotated in opposite directions.

(B) In the opening and closing body control apparatus for a vehicle, when the movable panel and the light shielding member simultaneously perform opening operations and a pinching is detected in either one of the movable panel and the light shielding member, both the movable panel and the light shielding member are stopped, and then only one of the movable panel and the light shielding member in which the pinching is detected performs a reverse operation.

According to the above configuration, the movable panel and the light shielding member do not perform the opening and closing operations in opposite directions also during reverse operations due to the detection of the pinching. Accordingly, it is possible to avoid the occurrence of the situation in which the first motor that drives the sunroof device and the second motor that drives the shade device are rotated in opposite directions.

(C) In the opening and closing body control apparatus for a vehicle, when the movable panel and the light shielding member simultaneously perform closing operations and a pinching is detected in either one of the movable panel and the light shielding member, both the movable panel and the light shielding member are stopped, and then both the movable panel and the light shielding member perform reverse operations.

According to the above configuration, the movable panel and the light shielding member do not perform the opening and closing operations in opposite directions also during reverse operations due to the detection of the pinching. Accordingly, it is possible to avoid the occurrence of the situation in which the first motor that drives the sunroof device and the second motor that drives the shade device are rotated in opposite directions. In addition, a relative positional relation between the movable panel and the light shielding member can be maintained.

An opening and closing body control apparatus for a vehicle for solving the above problem includes: a sunroof device configured to open and close a movable panel provided in a roof opening of a vehicle; a shade device configured to open and close a light shielding member provided below the movable panel; and a drive circuit configured to supply drive power to a first motor that drives the sunroof device and a second motor that drives the shade device. The drive circuit includes first to third arms connected in parallel in three rows and each including first and second switching elements connected in series, by turning on the second switching element in the first arm and the first switching element in the second arm, the first motor is rotated forward to drive the sunroof device to be opened, by turning on the second switching element in the third arm and the first switching element in the second arm, the second motor is rotated forward to drive the shade device to be opened, by turning on the first switching element in the first arm and the second switching element in the second arm, the first motor is rotated backward to drive the sunroof device to be closed, and by turning on the first switching element in the third arm and the second switching element in the second arm, the second motor is rotated backward to drive the shade device to be closed.

According to the above configuration, the sunroof device and the shade device can be individually driven with a simple configuration. Both the movable panel and the light shielding member provided in the roof opening of the vehicle perform opening operations and closing operations in the same direction. The first motor that drives the sunroof device and the second motor that drives the shade device are also rotated in the same direction when performing opening drive and closing drive. Therefore, according to the above configuration, a design of opening and closing drive control for the sunroof device and the shade device can be easily performed. Accordingly, the sunroof device and the shade device can be suitably driven to be opened and closed.

It is preferable that in the opening and closing body control apparatus for a vehicle, when the sunroof device is driven to be opened, the second switching element in the first arm is driven to be turned on/off by PWM control, when the shade device is driven to be opened, the second switching element in the third arm is driven to be turned on/off by the PWM control, when the sunroof device is driven to be closed, the first switching element in the first arm is driven to be turned on/off by the PWM control, and when the shade device is driven to be closed, the first switching element in the third arm is driven to be turned on/off by the PWM control.

That is, the movable panel driven by the sunroof device and the light shielding member driven by the shade device are different in size and weight. However, according to the above configuration, individual control can be performed in accordance with a driving force required for the opening and closing operation of the movable panel and a driving force required for the opening and closing operation of the light shielding member. As a result, for example, an opening and closing operation speed of the movable panel and an opening and closing operation speed of the light shielding member can be freely set. Accordingly, a degree of freedom for the design of the opening and closing drive control can be increased.

A driving force of the sunroof device and a driving force of the shade device can be individually controlled without driving the first and second switching elements constituting the second arm to be turned on/off by the PWM control. Accordingly, when the sunroof device and the shade device are driven, a load on the first switching element or the second switching element in the second arm, that is, a switching element through which both a current supplied to the sunroof device and a current supplied to the shade device flow, can be reduced.

It is preferable that in the opening and closing body control apparatus for a vehicle, the first and second motors have the same output characteristics.

According to the above configuration, the configuration can be simplified and the cost can be reduced by commonalizing specifications of the first motor that drives the sunroof device and the second motor that drives the shade device.

It is preferable that in the opening and closing body control apparatus for a vehicle, when both the movable panel and the light shielding member perform opening operations from a state in which both the movable panel and the light shielding member are at fully closed positions, the opening operation of the movable panel is started after the opening operation of the light shielding member is started.

That is, the light shielding member performs the opening operation first, so that the movable panel can keep covering the light shielding member spread inside the roof opening from above. Accordingly, the light shielding member can be protected. As a result, the movable panel and the light shielding member can simultaneously perform the opening operations and quickly reach fully open positions thereof.

It is preferable that in the opening and closing body control apparatus for a vehicle, when both the movable panel and the light shielding member perform closing operations from a state in which both the movable panel and the light shielding member are at fully open positions, the closing operation of the light shielding member is started before the closing operation of the movable panel is started, the light shielding member is stopped in the middle at a position closer to an open side than the fully open position of the movable panel, the movable panel performs the closing operation while the light shielding member is stopped in the middle, and the closing operation of the light shielding member is restarted after the closing operation of the movable panel is completed.

According to the above configuration, the movable panel and the light shielding member do not simultaneously perform the closing operations, so that even when a user performs an operation for stopping the movable panel at a middle position, the light shielding member performing the closing operation does not overtake the movable panel. Accordingly, it is possible to prevent the movable panel from being forgotten to be closed when the light shielding member after performing the closing operation is exposed to the roof opening. In addition, the load on the first switching element or the second switching element in the second arm, that is, the switching element through which both the current supplied to the sunroof device and the current supplied to the shade device flow, can be reduced.

In the vehicle, an opening and closing operation range of the light shielding member may extend to an opening operation side of the light shielding member than an opening and closing operation range of the movable panel. However, according to the above configuration, the light shielding member located closer to the open side than the fully open position of the movable panel performs the closing operation ahead of the movable panel, so that the whole closing operation time can be shortened.

According to this disclosure, the sunroof device and the shade device can be suitably driven to be opened and closed with a simple configuration.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An opening and closing body control apparatus for a vehicle, the apparatus comprising:
a sunroof device configured to open and close a movable panel provided in a roof opening of a vehicle;
a shade device configured to open and close a light shielding member provided below the movable panel; and
a drive circuit configured to supply drive power to a first motor that drives the sunroof device and a second motor that drives the shade device, wherein
the drive circuit includes first to third arms connected in parallel in three rows and each including first and second switching elements connected in series,
by turning on the second switching element in the first arm and the first switching element in the second arm, the first motor is rotated forward to drive the sunroof device to be opened,
by turning on the second switching element in the third arm and the first switching element in the second arm, the second motor is rotated forward to drive the shade device to be opened,
by turning on the first switching element in the first arm and the second switching element in the second arm, the first motor is rotated backward to drive the sunroof device to be closed, and
by turning on the first switching element in the third arm and the second switching element in the second arm, the second motor is rotated backward to drive the shade device to be closed.

2. The opening and closing body control apparatus for a vehicle according to claim 1, wherein
when the sunroof device is driven to be opened, the second switching element in the first arm is driven to be turned on/off by PWM control,
when the shade device is driven to be opened, the second switching element in the third arm is driven to be turned on/off by the PWM control,
when the sunroof device is driven to be closed, the first switching element in the first arm is driven to be turned on/off by the PWM control, and
when the shade device is driven to be closed, the first switching element in the third arm is driven to be turned on/off by the PWM control.

3. The opening and closing body control apparatus for a vehicle according to claim 2, wherein
the first and second motors have the same output characteristics.

4. The opening and closing body control apparatus for a vehicle according to claim 1, wherein
when both the movable panel and the light shielding member perform opening operations from a state in which both the movable panel and the light shielding member are at fully closed positions, the opening operation of the movable panel is started after the opening operation of the light shielding member is started.

5. The opening and closing body control apparatus for a vehicle according to claim 1, wherein
when both the movable panel and the light shielding member perform closing operations from a state in which both the movable panel and the light shielding member are at fully open positions, the closing operation of the light shielding member is started before the closing operation of the movable panel is started, the light shielding member is stopped in the middle at a position closer to an open side than the fully open position of the movable panel, the movable panel performs the closing operation while the light shielding member is stopped in the middle, and the closing operation of the light shielding member is restarted after the closing operation of the movable panel is completed.
